(19) United States
(12) Patent Application Publication
(10) Pub. No.: US 2004/0260531 A1
(43) Pub. Date: Dec. 23, 2004

(54) Emulation system and method

(76) Inventor: Matthew C Buckley, Devon (GB)

Correspondence Address: SCHNECK & SCHNECK, P.O. BOX 2-E, SAN JOSE, CA, 95109-0005, US

(21) Appl. No.: 10/489,292

(22) PCT Filed: Sep. 11, 2002
(86) PCT No.: PCT/GB02/04130

(30) Foreign Application Priority Data
Sep. 11, 2001 (GB) 012990.6

(51) Int. Cl. G06F 9/455

(52) U.S. Cl. 703/25

(57) ABSTRACT

An emulator block (30) for use in the development or testing of an embedded system, the emulator block (30) being configured to model a processing block (20) that includes a bus interface (22) and processing core logic (28), said emulator block comprising: an emulator bus interface comprising bus specific logic (24) and a Register Block (26), said emulator bus interface being configured to be substantially identical to the bus interface of the processing block that the emulator block is to model; and a core block emulator (32) configured, in use, to supply and receive signals to and from the Register Block (26) which mimic signals supplied and received to and from the processing core logic (28) of the processing block that the emulator block is to model.

### FIELD OF THE INVENTION

This invention relates, in general, to the field of integrated circuits that have one or more processing blocks (typically known in the art as IP blocks, or Intellectual Property blocks) for performing specific functions. More particularly, but not exclusively, the invention relates to methods of and systems for developing, testing and generating such integrated circuits and to methods for generating such systems.

### BACKGROUND TO THE INVENTION

As technology has advanced, larger and more complex electronic circuit designs can be formed as a single integrated circuit (IC). These advances, coupled with an increasing need to get products to market quickly, have forced designers to find new ways of quickly developing and testing electronic products.

As a means to help reduce the development time for a new product, designers have recognised that they will often have to concurrently develop the software and hardware for a given new product. To help this process, a number of tools have been designed that enable a system architect to specify a system design without having to worry about dividing the system into software and hardware. However, before a new system can be implemented a division between the hardware and the software must be specified.

At this point in the development process, software development and hardware development generally follow separate paths. The hardware and software designers will both be given a copy of the system specification created by the system architect, and then each team tends to develop and verify their bit of the system independently from the other. Once development is complete the two parts of the system are then re-united.

A major drawback of this method is there are many opportunities for information, such as the system specification for example, to be incorrectly reproduced or misinterpreted. It is also the case that changes are often made to the hardware or software specification as a project progresses, and these specification changes can often be miscommunicated, or not communicated at all, between the design teams. A lack of communication between the teams can cause serious problems during the subsequent system integration phase when the hardware and software designs are re-united.

A further problem for software designers concerns verification of their software. In the ideal world, software designs would be verified on a model of the system hardware, but in practise the software cannot be executed on real hardware until the development and implementation of the hardware has been fully completed.

One solution offered by some electronic design automation (EDA) tool vendors is known in the art as “co-verification”. In general terms, co-verification tools provide environments that allow engineers to simulate their software and hardware designs together. However, it is often the case that these simulations are too slow to allow real software designs to be verified.

An alternative to using a co-verification simulator would be to create a prototype hardware system. Software could then be run using “real, albeit prototype, hardware. However, there are still problems that must be overcome when attempting to verify the software design on a prototype hardware platform. In such instances, the hardware platform becomes a restriction when verifying the software, and in order to test a particular module in the software design it may be necessary to force the hardware platform into specific states. With the complexity of today's embedded system design, also called system-on-chip (SOC) designs, this can be a considerable problem. Often it simply may not be possible or practical to verify the software parts of an SOC design on the hardware platform.

As a result of these problems, software for SOC designs typically uses a prototype model of the hardware to verify the software design, and the software is then tested on the real hardware as soon as a definitive hardware implementation is available. This approach is slow and prone to errors. In particular, it is often the case that inconsistencies in the hardware/software interface can be missed, and these inconsistencies can cause problems during hardware/software integration. If problems are encountered it is often the case that they are difficult to identify, and as a result they tend to delay development.

A more worrying prospect with this approach is that it is conceivable a problem in the hardware/software interface could be missed altogether. This could result in a product that performs unreliably in its target application, and could even necessitate a wholesale product recall.

It is apparent from the above that a number of significant problems are associated with previously proposed system design solutions. It is an aim of the present invention to alleviate at least some of these problems

### STATEMENT OF THE INVENTION

In pursuit of this aim, one aspect of the invention provides an emulator block for use in the development or testing of an embedded system, the emulator block being configured to model a processing block that includes a bus interface and processing core logic, said emulator block comprising:

a bus interface that is configured to be substantially identical to the bus interface of the processing block that the emulator block is to model, the emulator block bus interface comprising bus specific logic and a Register Block; and

a hardware core block emulator configured, in use, to supply and receive to and from the Register Block output and input signals, respectively, which mimic output and input signals of the processing core logic of the processing block that the emulator block is to model.

Stated differently, one aspect of the invention provides a peripheral processing emulation (PPE) block for system development or testing of an embedded system, the PPE block modelling a peripheral processing (PP) block that includes a bus interface and PP core logic, wherein the PPE block comprises: a bus interface that is substantially identical to said PP block bus interface and which includes bus specific logic and a Register Block; and a hardware core block emulator that models, in use, the input and output of the PP core logic to the Register Block.

By employing an emulator block of the kind defined above, the application software be developed and tested on hardware and the software development can progress much more quickly. In addition, the interface between the software and hardware designs can be verified together with the application software, thereby increasing the likelihood of everything working as planned when the software and hardware is re-united. A further advantage is that any changes to the hardware can be accommodated relatively simply.

Another aspect of the present invention relates to a method of developing an embedded system that includes at least one peripheral processing block (PP block), the method comprising the steps of: developing and verifying application software for the peripheral processing block on a hardware emulation of said processing block; and integrating and testing the system using said peripheral processing block and said emulation simultaneously.

In this way sub-systems of the PP block can be incorporated individually into the embedded system and the emulation block can be used to emulate the remaining sub-systems, thereby enabling the system to be verified and tested.

According to another aspect of the present invention, there is provided a method of automatically generating a generator module, wherein said generator module is adapted to automatically generate at least one package of information suitable for use in, or for components of, a complex electronic system from a machine-readable specification.

In this way the software for programming a generator module does not need to be written manually by a programmer. Instead, many steps can be performed automatically.

Other preferred aspects of the invention, and features of those aspects, are set out in the claims and elsewhere in this specification.

### BRIEF DESCRIPTION OF THE DRAWINGS

Preferred embodiments of the invention will now be described, by way of illustrative example only, with reference to the accompanying drawings, in which:

FIG. 1 is a schematic block diagram of an embedded system;

FIG. 2 is a schematic block diagram of a peripheral processing block;

FIG. 3 is a schematic block diagram of an emulator block that is configured to emulate a peripheral processing block of the type depicted in FIG. 2;

FIGS. 4, 5, 8, and 9 are schematic block diagrams of four different ways in which a peripheral processing emulator block of the type shown in FIG. 3 might be implemented;

FIGS. 6 and 7 are block diagrams illustrating two further ways in which a peripheral processing emulator block of the type shown in FIG. 3 might be implemented;

FIG. 10 is a flowchart diagram illustrating the steps employed in a previously proposed method of generating a generator module; and

FIG. 11 is a flowchart diagram illustrating the steps of a method of generating a generator module in accordance with another aspect of the present invention.

### DETAILED DESCRIPTION OF PREFERRED EMBODIMENTS

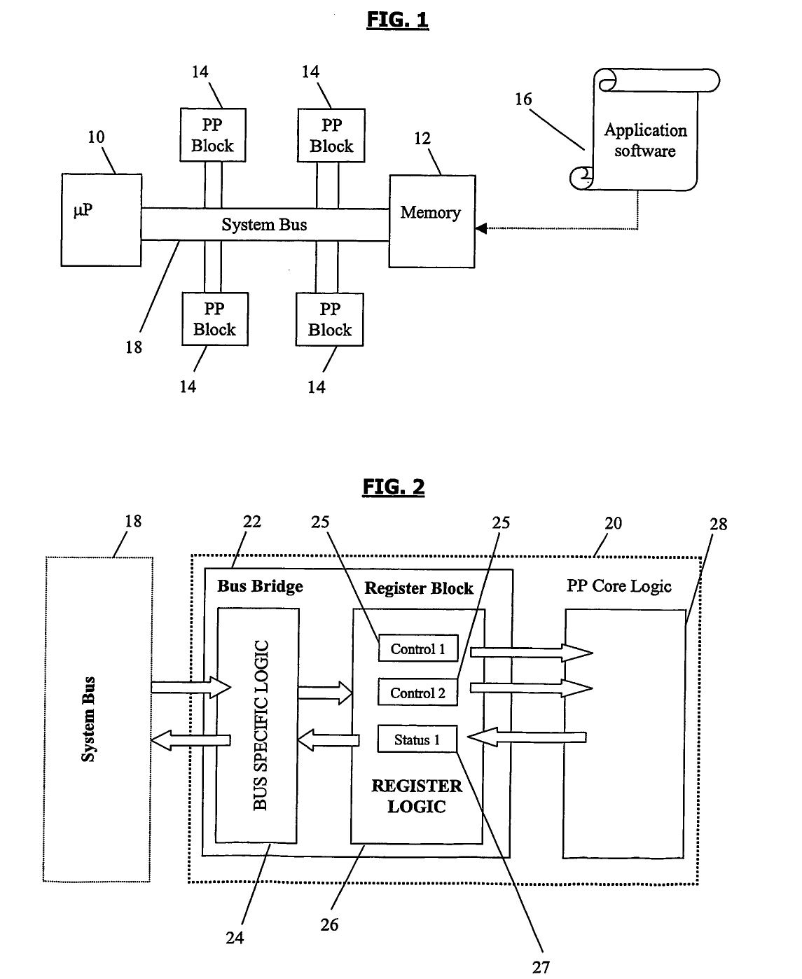

As mentioned above, FIG. 1 is a schematic illustration of an embedded system in which the present invention may be implemented. Typically, the system includes a microprocessor 10, a memory 12, and one or more peripheral processing blocks (PP blocks) 14 for performing specific functions. Application software 16 is stored within the memory 12, and a system bus 18 connects the individual components 10, 12, and 14 of the system.

A Model of an IP Block

FIG. 2 is a schematic illustration of a PP block (or IP block as they are sometimes known). The PP block 20 includes a bus interface 22 and a PP core logic block 28. The bus interface 22 includes a first portion; the Bus Bridge 24; which contains bus specific logic, and a second portion; the Register Block 26; which contains register logic. The register logic includes typically a number of address-mapped registers and the bus specific logic provides the interface to the system bus 18.

The microprocessor's view of the system takes the form of a series of interface points in its address space that correspond to each PP block. These interface points are usually implemented as memory mapped registers which are connected to the microprocessor via the system bus.

The only awareness that a processor has of each of the PP blocks in a system is via these memory-mapped registers. Typically writable registers are used to control the function of PP blocks and transfer data to PP blocks. Readable registers, on the other hand, are used to monitor the status of the PP blocks and transfer data from the PP blocks.

In order to model any of the PP blocks in a system we need not to model the function of the entire PP block. Rather, we can simply model the PP block in terms of its memory-mapped registers.

Each PP block model has the following basic requirements:

To supply valid status information via the readable registers.

To supply valid data via the readable registers.

To update the readable registers as a result of accesses to writable registers.

To accept data via writable registers.

Accordingly, in order to create a similar PP block model in hardware (i.e. an emulator block) all that we need to do is to implement the memory mapped registers and have a method of meeting the above requirements.

In order to implement the memory mapped registers we provide a bus interface that is substantially identical to the bus interface 22, including the Bus Bridge 24 and the Register Block 26, as shown in FIG. 2. As explained above, to create a processor model of the PP block there is no need to implement the PP core logic itself (the PP core logic is the part of the PP block that implements the functionality of the block), rather all that is required is a means for supplying values to the readable registers and a means for reading values of the writable registers in the Register Block 26.

This is accomplished by means of a mirror image of the Register Block, or in other words a second Register Block that mirrors the first Register Block 26. The mirror image register has the following rules:

A write only register mirrors a read only register.

A read only register mirrors a writable register.

By implementing a software model of the PP core logic, it is possible to mimic the function of the PP block by using the software model to drive the mirror image register. In general terms, the PP core logic software model is responsible for monitoring the data written to the PP model and supplying the data to be read from the PP model.

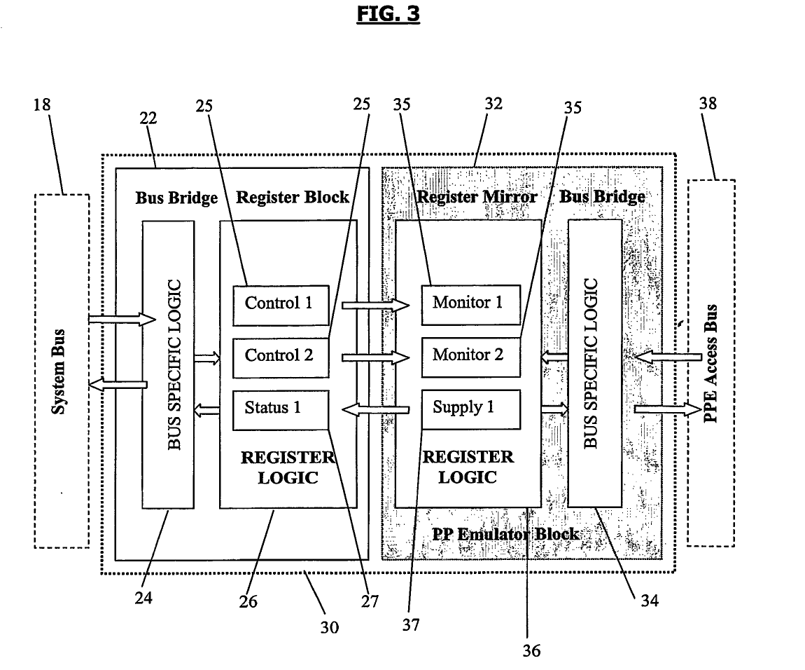

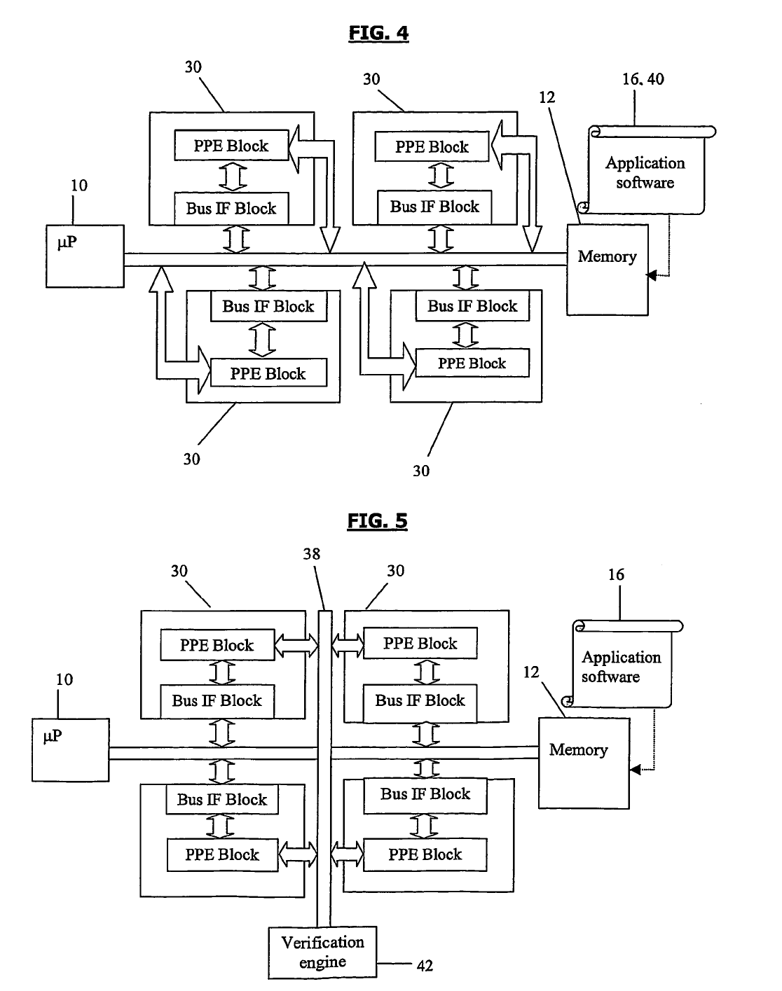

The architecture of a PPE (peripheral processor emulator) block according to one embodiment of the invention is shown in FIG. 3.

As shown, the PPE block 30 includes a bus interface 22 that is substantially the same as that of the PP block 20. However, instead of PP Core Logic block 28, the PPE block includes a core emulator block 32. The core emulator block 32 includes the mirror 36 of the register block 26 and a Bus Bridge 34. Bus Bridge 34 contains bus specific logic that interfaces the PPE block with a PPE access bus 38 that is used by the core logic model to supply data to and read data from the mirror 36.

In general terms, the PPE block shown in FIG. 3 is the simplest form of emulator in accordance with the invention. It will be appreciated, however, that more complex versions of PPE blocks can be realised, as will be shown below.

A Model of an Embedded System

By replacing each of the PP blocks in a system with PPE blocks, as described above, it is possible to build up a hardware model of the complete embedded system. There are two methods for doing this.

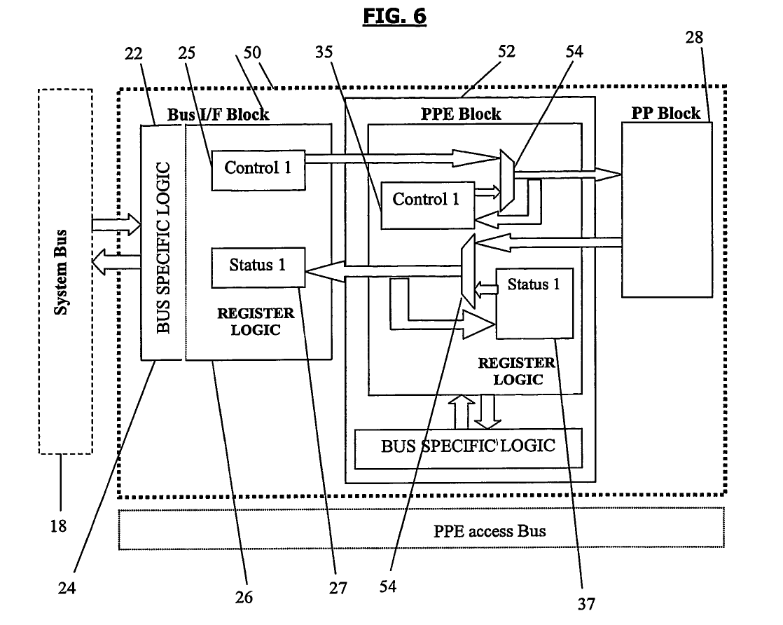

The first method is illustrated in FIG. 4 and involves using an embedded processor 10 to run software applications 40 which model the PP Core Logic. This means that the PPE access bus 38 is connected to the system bus 18. This can be done directly or via a Bus Bridge (now shown). The embedded processor 10 then has access to all of the registers (35, 37) in the PPE block 22, and the core logic modelling software applications 40 then run concurrently with the application code 16 on the embedded processor 10.

In many applications the embedded processor 10 will not have enough spare bandwidth to run the PP Core Logic model application software 40 at the same time that it is running the application software 16, and to combat this problem—in a second embodiment—a separate verification engine 42 is used to run PP Core Logic models. FIG. 5 shows a block diagram of a system modelled in this way.

The verification engine 42 can take many forms in order to meet the requirement of modelling the behaviour of a PP block. In its simplest form it could be a state machine or direct memory access (DMA) that inserts predefined values into the PPE blocks at predefined times. These values may be specified as a set of vectors. Alternatively a more complex solution could be a second microprocessor running a model of the PP block, for example written in C.

The hardware system models as described above can be created as soon as the hardware/software interface is defined. The hardware model of the system can for example be implemented using programmable logic devices (PLD's). This means that the application software can be developed on a real hardware system right from the beginning of the software design phase.

The IPE and System Integration

Previously we have looked at creating a hardware model of a system using the PPE block as a model of the real PP block. In such a system the PPE block is used as a replacement for the real PP block until the real PP block design is completed. Now we will see how the PPE could be used together with the real PP block or, more specifically, the PP core logic block 28, during system integration debugging and testing.

A first embodiment of such a system is described below with reference to FIG. 6.

In this embodiment the complete PPE block 52 includes a bus interface 22, PPE core logic block 52 and PP core logic block 28. The PP core logic block 28 is connected to the PPE core logic block 52.

In order to use the PPE core logic block 52 in conjunction with the real PP block core logic block 28, a set of multiplexers 54 has been added to the PPE block.

The multiplexers 54 in the PPE core logic block 52 allow the PP core logic block 28 to be selectively replaced by a software model 40 of the PP core logic running on the processor connected to the PPE access bus 38.

The system may be used in a first and a second mode, and in the first mode the multiplexers 54 can be switched such that the PP core logic 28 is disconnected from the Register Block 26. In this mode the PPE core logic block 52 is used to supply data to read only registers 25 in the Register Block 26 and monitor the contents of writable registers 27 in the Register Block 26.

In the second mode the multiplexers 54 are transparent to the PP core logic 28 and signals are fed through the PPE core logic block 52. When in this state the PPE core logic 52 can be used to monitor the signals passing between the processor 10 and the PP core logic.

In the preferred embodiment, the first or second mode of the PPE block 50 can be chosen individually for each register (35, 37) or signal.

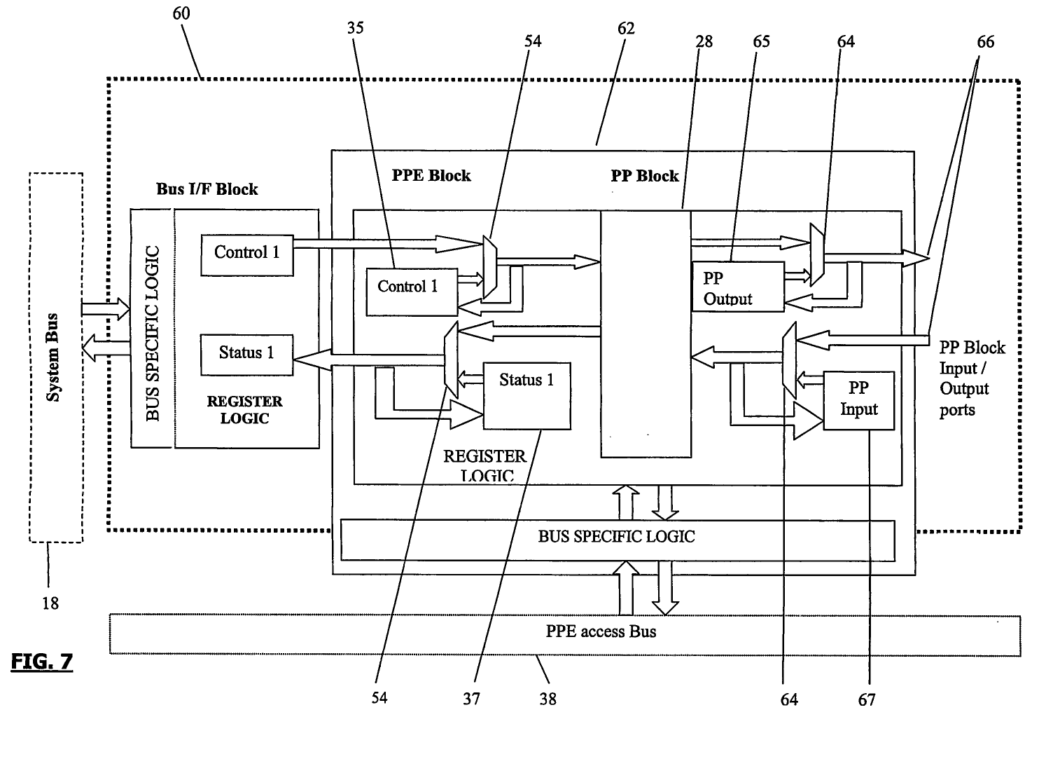

FIG. 7 illustrates a second embodiment that shows how the PPE block could be used together with the real PP block or more specifically, including the PP core logic. The second embodiment is similar to the first embodiment. However, in the second embodiment the PPE core block 62 is further able to substitute any signals that are external inputs or outputs to the PP core logic block 28. To achieve this, the PPE core logic block 62 provides a second set of multiplexers 64, ports 66 and registers 65 and 67 mirroring the PP block input and output.

Once again, this system may be used in a first and a second mode. In the first mode the multiplexers 54, 64 are switched so that the PP core logic block 28 is disconnected from the Register Block 26 and also from the PP block input and output ports 66. Thus the PPE core block 62 can be used to supply any signal or combination of signals to the bus interface 22, the PP core block 28 or any hardware connected to the PP block via input and output ports 66.

In the second mode the multiplexers 54, 64 are transparent to the PP core block 28 and signals are fed through the PPE core logic block 62. In this mode the PPE block 62 can be used to monitor the signals passing between the processor 10 and the PP core logic 28 or between any other hardware connected via the ports 66 and the PP core logic block 28.

As with the first embodiment the first and second mode of the PPE block 62 can be chosen individually for each register (35, 37, 65, 67) or signal.

The architecture shown in FIG. 6 and FIG. 7 is intended for use during system integration. Initially when the hardware/software interface has been specified, all of the PP blocks in the system may be modelled using PPE blocks. In this way a hardware model of the system can be created as outlined previously. Application software is then developed using this hardware model of the system. Sets of regression tests can be developed using the system model.

As the real PP core logic blocks are developed and tested, each real PP core logic block can be added to the system one at a time. After each PP core logic block is added the regression tests are run on the system. If any errors are introduced as the real PP core logic blocks replace the software models, then the previously generated regression tests will identify them.

The PPE can also be used to monitor hardware/software communication via the memory-mapped registers in the Register Block. Again, this will help to identify any problems with hardware/software interaction that are found during regression testing.

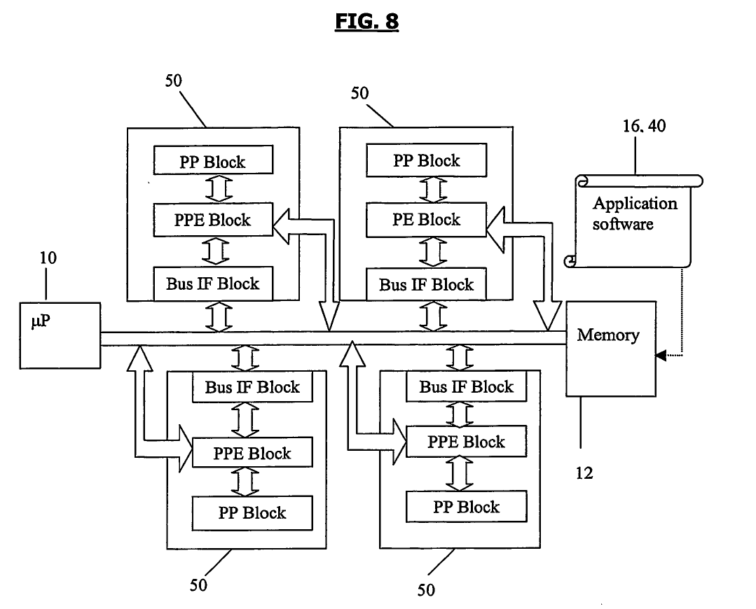

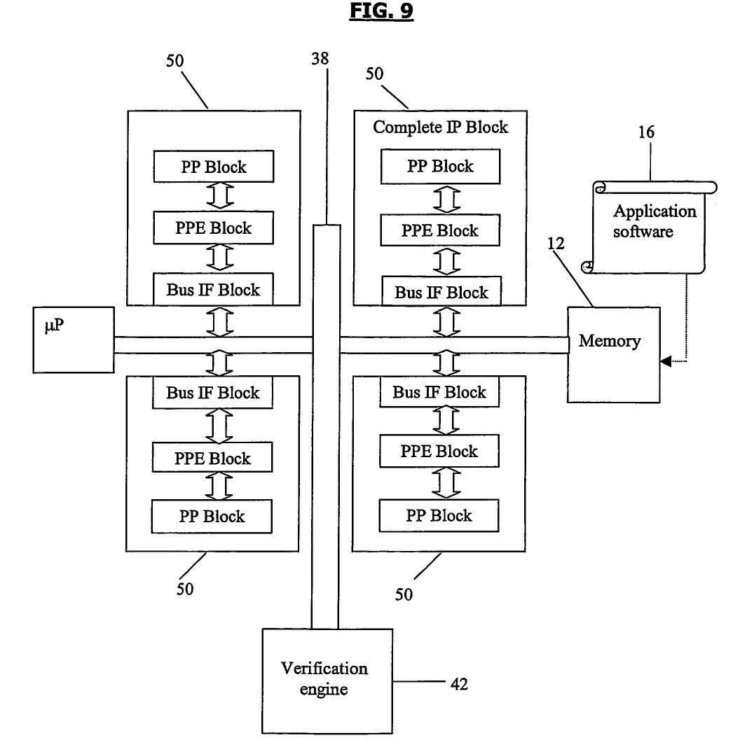

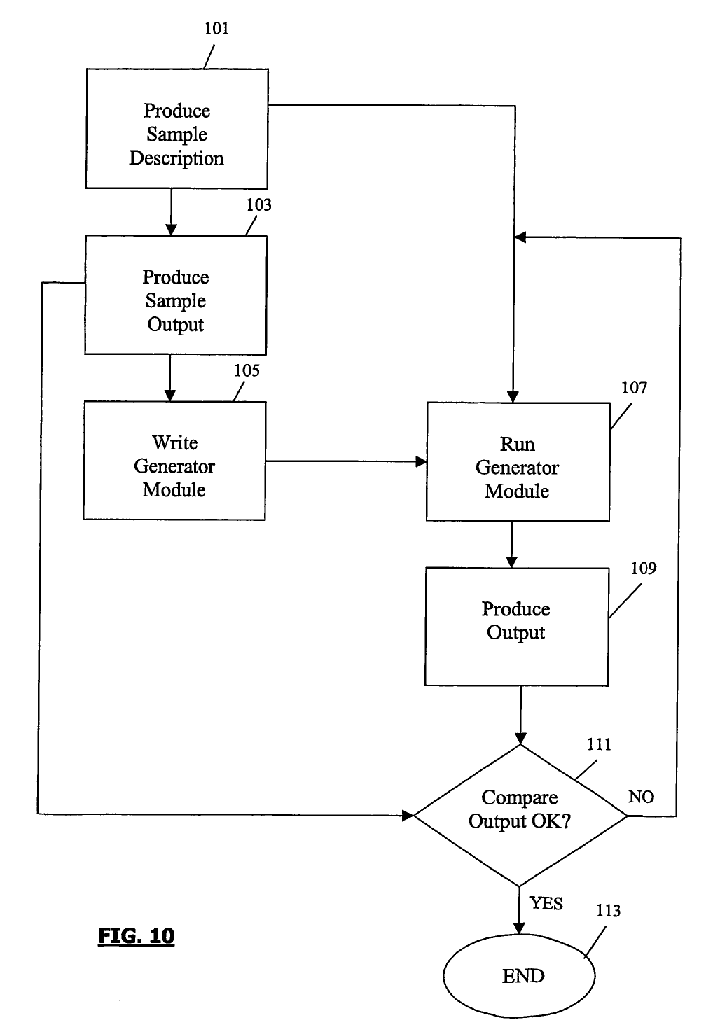

As with earlier embodiments, the model of the complete embedded system can be realised either by running the software models of the PP core logic block on the processor 10 or by using a verification engine 42, as shown in FIGS. 8 and 9.

Generating the PP Block Models

A drawback of modelling an embedded system using the methods outlined above is that there is still a significant amount of effort required to generate the PPE blocks. A method of reducing the effort required to implement the PPE blocks is to automatically generate them. There are tools available that automatically generate the Bus Bridge and Register Block parts of a PP block. Since these parts of the PP block are also used in the PPE block, this halves the effort required to produce the PPE block. The EASI-Gen™ tools created by Beach Solutions Ltd. for example enable the automatic generation of the Bus Bridge and Register Block parts of a PP block. These tools capture the description of the hardware/software interface as a set of memory mapped registers. This description can then be used to generate outputs such as a register transfer level (RTL) descriptions of the Bus Bridge and Register Block.

The EASI-Gen tools can automatically generate the following illustrative items:

A complete RTL description of the Bus Bridge and register bridge block parts of the PP block.

A complete RTL description of the PP block.

The PPE block.

A complete set of software access functions that can be used to access the registers in the PP block.

A set of software access functions that can be used to access the registers in the PPE block.

A function reference manual that describes all of the software access functions listed above.

A manual detailing the software/hardware interface for each PP block in a system.

These items are generated by “generator modules” which are software applications running on a computer. The modules operate on a so-called master specification which may, for example, be in the form of a document, a database, or a library, and which contains the initial hardware/software interface description. An advantage of using these tools is that as all of the items are generated from the same source they are guaranteed to be consistent.

Using a tool such as this, hardware models of each PP block in the embedded system can be automatically generated as soon as the hardware/software interface of a design has been specified.

This means that potentially as soon as the division between hardware and software is specified, software development can begin on “real” hardware. The parts of the hardware that are directly visible to the embedded processor will be re-used in the PP block implementation. Consequently, there should be no errors introduced into the hardware/software interface when replacing the PPE block with the real PP block.

Further advantages of such an automatic generation are realised when changes to the hardware/software interface specification are introduced. Such changes have little impact on project timescales because all of the parts of the design that implement this interface can be automatically re-generated.

Generating Generators

Generator modules are usually produced by manual coding of software applications running on a computer. A convenient computer language for programming generator modules is for example Perl (Practical extraction and report language). However, any other general-purpose language may be used.

The generator code provides access to the specification data containing the relevant information of the component to be generated. The specification data may be for example stored in a library to which the generator code has access.

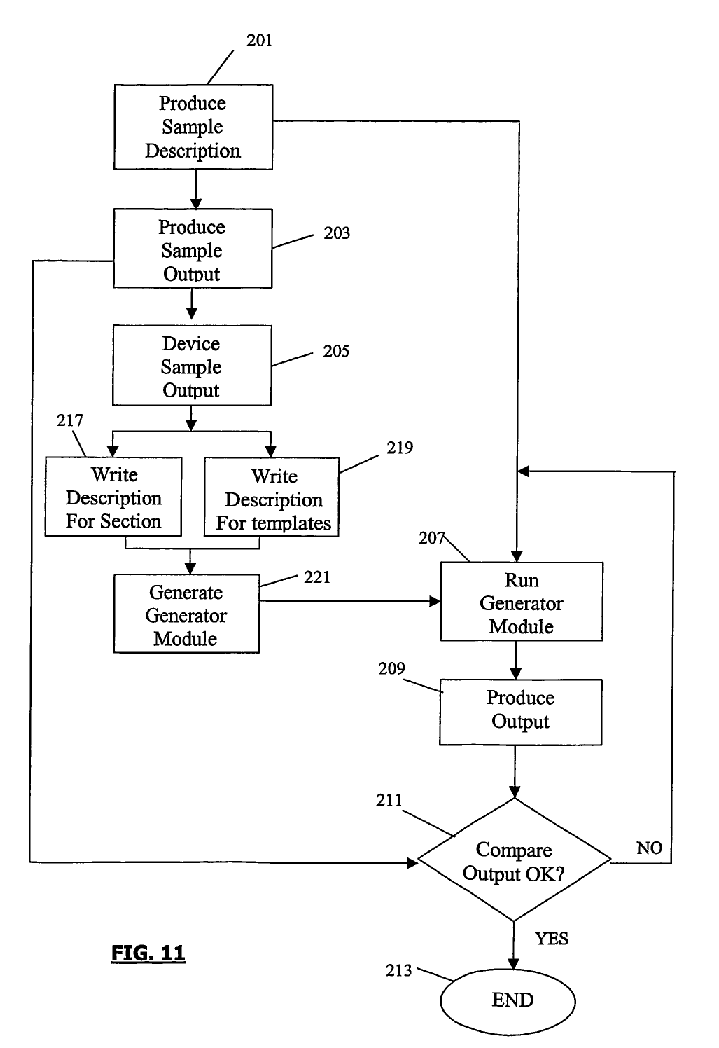

FIG. 10 illustrates the steps involved in the manual development of a generator module.

In step 101 the programmer develops a sample component description. This description contains all relevant information of the component to be generated. The component description allows for a wide variation in design styles and may be provided in the form of a database for easy access. The component description will be used to test the new generator.

In step 103 the programmer produces a sample document that is a representation of the desired output from the generator to be developed. After this the programmer can start to write the generator module, for example using the computer language Perl (step 105). The generator module software uses the information of the sample component description or database generated in step 101 to create an output document which is produced in step 103.

In steps 107 and 109 the generator module is tested on the sample component description developed in step 101, and is verified by comparing the output document with the sample output of step 103. The programmer checks in step 111 whether the generator output is as desired. If the output is not satisfactory, then steps 107 to 111 are repeated until the desired output is obtained (step 113).

The main disadvantage of the described procedure is that the production of the generator module is slow and time-consuming. A person learning how to produce a generator needs to know the internal library arrangement and may also need to learn a computer language as Perl in order to be able to program generator modules. Also, the quality of the resulting code depends greatly on the level of skill and understanding the programmer possesses.

A further disadvantage is that all changes, which might be introduced for example into the specification data format, require corresponding manual changes to each of the generators. Moreover, all existing generator code has to be re-written if a new implementation language or new technology is used.

These problems can be alleviated by automatically generating generator modules from a machine-readable specification.

FIG. 11 illustrates the steps involved in automatically creating a generator module. The first two steps of producing a sample component description (step 201) and a sample of the desired output of the generator module (step 203) are similar to step 101 and 103 of the manual development of the generator module. In step 205 the user then divides the sample document generated in step 203 into sections. These sections may contain so-called templates, i.e. preformed blocks of output to the generator. Each section and each template is given a name for future identification. In steps 217 and 219 the user writes a description using a system independent mark-up language such as XML (extensible mark-up language). This can for example be done using the Beach Solutions generator sections/template description format in XML.

In, step 221 the automatic generator generator then translates the individual generator descriptions and templates into a single executable module. Steps 207 to 213 of testing and verifying the generator module are again similar to step 107 to 113 of FIG. 10.

The advantage of this automatic approach is that the user does not need to know the programming language and library structure of the underlying system in order to generate generator modules. The individual steps are smaller and easier to achieve. In this way the new approach is faster compared to the manual generation. Automatically generated code is consistent and its quality depends only upon the generator and not on the level of skills of the user.

Changes in the specification data format only require changes in the generator generator. The subsequent process of updating the generator modules only requires a rerun of the generator generation process and thus is an automatic process.

Similarly, an alternative implementation language may be implemented with no or only minor changes to the generator descriptions or templates.

It is to be understood that the embodiments described above are preferred embodiments only. Namely, various features may be omitted, modified, or substituted by equivalents without departing from the scope of the present invention.

For example, whilst aspects of the invention have been described with reference to production of generators for IP emulation, it will be appreciated that the teachings of the invention may equally well be employed to produce a generator for another purpose.

1. An emulator block for use in the development or testing of an embedded system, the emulator block being configured to model a processing block that includes a bus interface and processing core logic, said emulator block comprising:
an emulator bus interface comprising bus specific logic and a Register Block, said emulator bus interface being configured to be substantially identical to the bus interface of the processing block that the emulator block is to model; and
a core block emulator configured, in use, to supply and receive signals to and from the Register Block which mimic signals supplied and received to and from the processing core logic of the processing block that the emulator block is to model.

2. An emulator block according to claim 1, wherein the core block emulator further comprises bus specific logic.

3. An emulator block according to claim 1 or 2, wherein the core block emulator is adapted to supply input values to the readable registers of the Register Block and is further adapted to read values of the writable registers of the Register Block.

4. An emulator block according to claim 1, 2 or 3, wherein the core block emulator comprises a mirror of the register logic.

5. An emulator block according to any preceding claim, wherein the core block emulator is adapted to monitor data supplied to the core block emulator and to supply data from the core block emulator.

6. An emulator block according to any preceding claim, further comprising the processing core logic of the processor block, said processing core logic being connected to the core block emulator.

7. An emulator block according to claim 6, wherein said core block emulator further comprises a set of multiplexers connecting the bus interface of the emulator block and the processing block core logic, to enable the core block emulator to be used in either of a first or a second mode.

8. An emulator block according to claim 7, wherein in said first mode the processing block core logic is disabled and the core block emulator is adapted to supply any signal or combination of signals or to read any signal or combination of signals from the bus interface.

9. An emulator block according to claim 7 or 8, wherein in said second mode the bus interface is connected to the processor block core logic via said multiplexers and the core block emulator is adapted to monitor the input and output of the processor block core logic to the register of the bus interface.

10. An emulator block according to claim 7, wherein said core block emulator is adapted to supply values substituting external inputs to said processing block core logic and/or is adapted to read values substituting external outputs of said processing block core logic.

11. An emulator block according to claim 10, wherein said core block emulator further comprises a further set of multiplexers coupling the processor block core logic to processor block core logic inputs and and/or outputs, enabling use of the core block emulator in a first and second mode.

12. An emulator block according to claim 11, wherein in said first mode the processor block core logic is disabled and the core block emulator is adapted to supply any signal or combination of signals to the bus interface and the external processor block core logic inputs and/or read any signal or combination of signals from the bus interface and the external processor block core logic outputs.

13. An emulator block according to claim 11 or 12, wherein in said second mode the bus interface and the external processor block core logic inputs and outputs are connected to the processor block core logic via said multiplexers and the core block emulator is adapted to monitor the input and output of the 10 processor block core logic to the register of the bus interface and the external processor block core logic inputs and outputs.

14. An emulator block according to any of claims 8 to 13, wherein said first or second mode can be chosen for each register or signal individually.

15. An emulator block according to any preceding claim, wherein said emulator block is implemented in a programmable logic device.

16. An emulation of an embedded system comprising: a microprocessor; a memory; one or more emulator blocks according to any of claims 1 to 15; and
a system bus operable to interconnect the aforementioned components.

17. An emulation system according to claim 16, further comprising one or more processing blocks operable to perform specific finctions.

18. An emulation system according to claim 17, wherein said one or more emulator blocks are controlled by application software adapted to run on said microprocessor or a verification engine.

19. An emulation system according to claim 16, 17 or 18, wherein a bus port of one or more of said emulator blocks is connected to the system bus.

20. An emulation system according to any of claims 16 to 19, further comprising a verification engine.

21. An emulation system according to claim 20, wherein the verification engine is connected to said one or more emulator blocks via the core block emulators.

22. An emulation system according to claim 20 or 21, wherein the verification engine is a DMA or state machine.

23. An emulation system according to claim 20 or 21, wherein the verification engine is a second microprocessor.

24. A method of automatically generating a peripheral processing emulation block according to any of claims 1 to 15 using a description of address mapped registers, access types and external ports.

25. A method of developing an embedded system that includes at least one peripheral processing block, the method comprising the steps of developing and verifying application software for the peripheral processing block on a hardware emulation of said processing block; and
integrating and testing the system using said peripheral processing block and said emulation simultaneously.

26. A method of automatically generating a generator module, wherein said generator module is adapted. to automatically generate at least one package of information suitable for use in, or for components of, a complex electronic system from a machine-readable specification. 03/023658 PCT/GBO2/04130

27. A method according to claim 26, wherein said at least one information package may include any of the following: software interface, bus interface, a description of a register in hardware description language (HDL), user documentation, test software, debugging or instrumentation code or device driver software.

28. Computer program product means comprising one or more software items that are operable, when executed in an execution environment, to perform one or more of the method steps of claim 26 or 27.
